(19) United States
(12) Patent Application Publication
(10) Pub. No.: US 2007/0028475 A1
(43) Pub. Date: Feb. 8, 2007

(54) Spherical diameter measuring scale

(76) Inventor: Ciber Chiu, Changhua Hsien (TW)

Correspondence Address: RABIN & Berdo, PC, 1101 14TH STREET, NW, SUITE 500, WASHINGTON, DC, 20005, US

(21) Appl. No.: 11/493,594

(22) Filed: Jul. 27, 2006

(30) Foreign Application Priority Data
Aug. 8, 2005 (TW) 094213501

(51) Int. Cl. G01B 3/10

(52) U.S. Cl. 33/555.4

(57) ABSTRACT

A sphere diameter measuring scale has a flexible ruler, and a zero is marked on one end. Multiple calibrations are evenly marked on the same face with the zero. Each scale has a reading number representing a corresponding diameter length, and when an exercise health ball or a ball chair is filled with air, the semi perimeter and the diameter length of the ball can be obtained conveniently.

### BACKGROUND OF THE INVENTION

1. Field of the Invention

The present invention relates to a measuring scale, and particularly relates to a spherical diameter measuring scale.

2. Description of the Related Art

The exercise health ball or ball chair is popular at present, and both of them have a hollow resilient ball, which are filled with air or liquid. To facilitate the setting up, manufacturers normally provide a diameter length of the charged ball.

Like a balloon, the diameter of the inflatable ball will change depending on the quantity of the filling air or liquid. Customers can not precisely control the diameter of the inflatable ball, so they always measures the ball with a conventional measure scale, but this is inconvenient and the measure result is imprecise.

Therefore, the invention provides a measure scale to mitigate or obviate the aforementioned problems.

### SUMMARY OF THE INVENTION

The main objective of the present invention is to provide a sphere diameter measuring scale, which comprises a flexible ruler. In one face of the ruler, a zero is marked in one end of the flexible ruler, and multiple calibrations are evenly marked on the same face with the zero, wherein each scale has a reading number representing a corresponding diameter length.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the measuring scale in accordance with this invention;

FIG. 1A is an enlarged perspective view of the measuring scale in FIG. 1.

FIG. 2 is an operational perspective view of the the measuring scale in FIG. 1 showing that the measuring scale is used to measure a diameter of a ball; and

FIG. 3 is an operational plan view of the measuring scale in FIG. 1.

### DETAILED DESCRIPTION OF THE PREFERRED EMBODIMENT

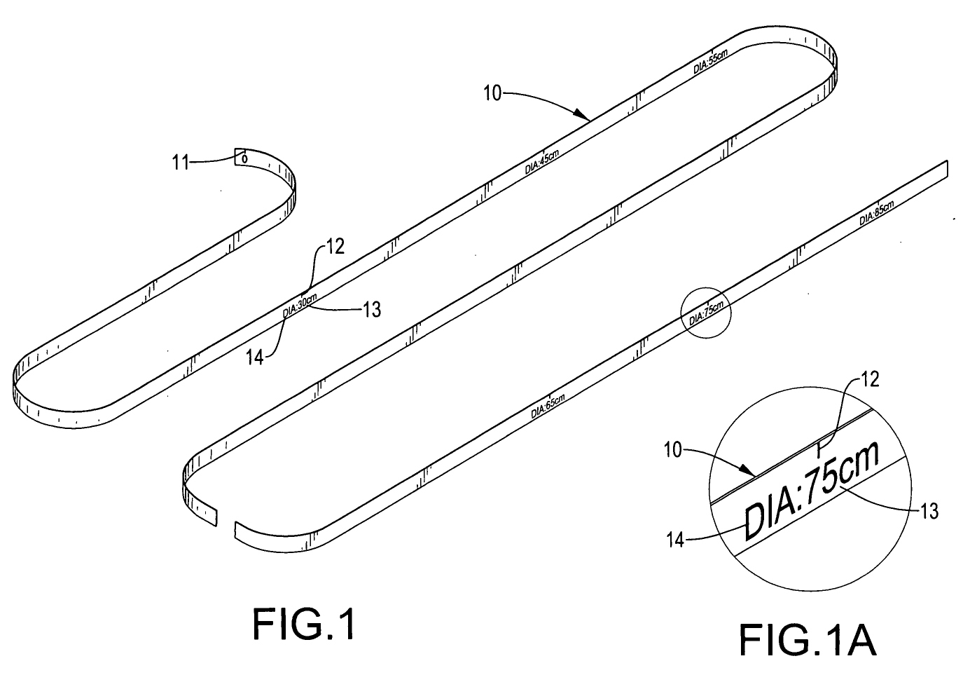

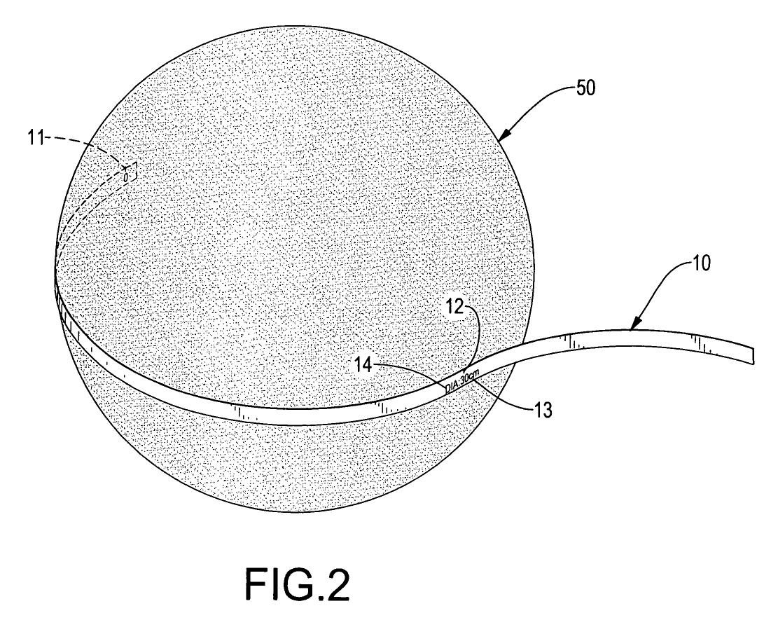

With reference to FIGS. 1 and 2, a measuring scale includes a flexible ruler (10). On one face of the ruler (10), a zero (11) is marked at one end, multiple calibrations (12) are evenly marked on the same face, and each calibration has a reading number (13) representing a corresponding diameter length.

The corresponding diameter length is equal to the ruler length/π

To indicate that the reading number (13) representing the corresponding diameter length, but not the ruler length, a symbol “DIA” (14) standing for diameter is marked beside each reading number (13).

If a user wants to measure half of a sphere, a diameter length of the sphere is two times of the corresponding reading number (13), the semi perimeter is π/2 times of the corresponding reading number (13). If a user wants to measure the whole sphere, a diameter length of the sphere is equal to the corresponding reading number (13), and the perimeter is π times of the corresponding reading number (13).

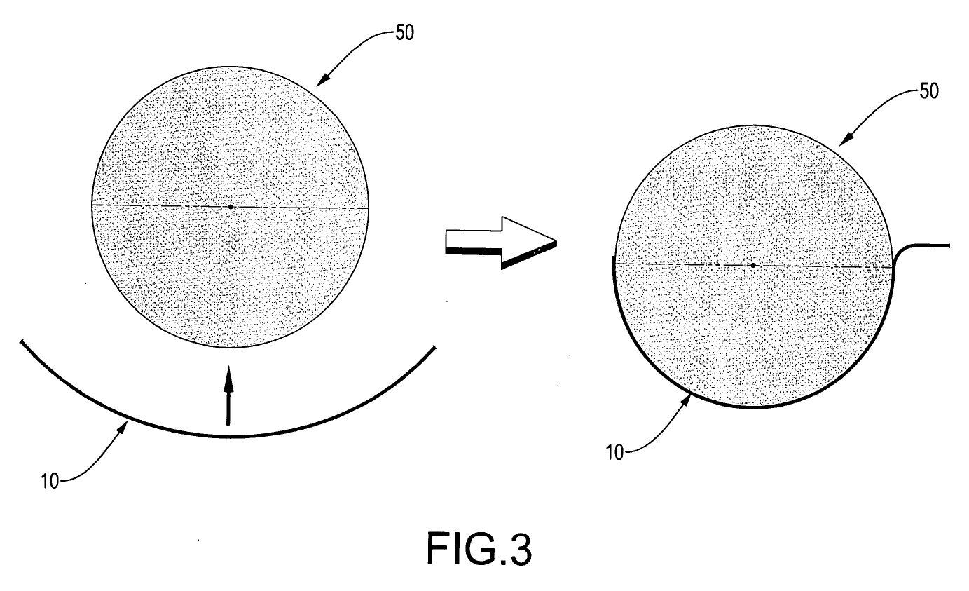

With reference to FIGS. 2 and 3, when an exercise health ball or a ball chair is filled with air, the semi perimeter and the diameter length of the ball can be read and obtained conveniently.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sphere diameter measuring scale comprising a flexible ruler, in one face of the ruler, a zero marked in one end of the flexible ruler, multiple calibrations evenly marked on the same face with the zero, wherein each scale has a reading number representing a corresponding diameter length.

2. The sphere diameter measuring scale as claimed in claim 1, wherein a symbol standing for diameter is marked beside each reading number.

3. The sphere diameter measuring scale as claimed in claim 2, wherein the symbol standing for diameter is “DIA”.
